(19) United States
(12) Patent Application Publication
(10) Pub. No.: US 2026/0358120 A1
(43) Pub. Date: Nov. 12, 2026

(54) Vehicle Lift Structure With Integrated Visual Alignment Guidance

(71) Applicant: Hunter Engineering Company, Bridgeton, MO (US)

(72) Inventors: Matthew Hussey, St. Louis, MO (US); Anthony Troglio, Pacific, MO (US)

(21) Appl. No.: 19/662,943

(22) Filed: Apr. 29, 2026

Related U.S. Application Data
(60) Provisional application No. 63/803,176, filed on May 9, 2025.

(51) Int. Cl. G01B 21/26; B60S 5/00; B66F 7/00; H05B 47/155

(52) U.S. Cl. CPC G01B 21/26; B60S 5/00; B66F 7/00; H05B 47/155

(57) ABSTRACT

A vehicle lift system incorporates a set of lights disposed to illuminate the underside of a supported vehicle in proximity to each wheel of the vehicle. The lights are controlled by an associated vehicle measurement or inspection system to dynamically vary at least one of color, hue, intensity, or illumination pattern of the illuminating light in response to measurements of alignment angles for the individual wheels and/or axles, providing an operator with a visual guidance during alignment angle or vehicle parameter adjustments.

### CROSS-REFERENCE TO RELATED APPLICATIONS

The present application is related to, and claims priority from, co-pending U.S. Provisional Patent Application Ser. No. 63/803,176 filed on May 9, 2025 which is herein incorporated by reference.

### STATEMENT REGARDING FEDERALLY SPONSORED RESEARCH

Not Applicable.

### BACKGROUND OF THE DISCLOSURE

The present application is related generally to vehicle lifts or support racks, and in particular, to a vehicle lift or support rack utilized in combination with a vehicle wheel alignment measurement and/or inspection system to provide a service technician with localized visual guidance for conducting wheel alignment angle adjustments to a vehicle supported on the vehicle lift or support rack.

Numerous vehicle measurement and adjustment procedures require or benefit from elevating a vehicle undergoing an alignment service to a convenient working height for a service technician. As such, it is common practice for the service technician to drive the vehicle onto an vehicle lift located within a service bay or vehicle inspection area, in proximity to the alignment measurement equipment, such as shown in FIG. 1. A typical vehicle lift, consists of two parallel runways, onto which the wheels of the vehicle are driven. An approach end of the vehicle lift may include a set of inclined ramps over which the vehicle drives as it moves onto the runways, while the opposite end of the vehicle lift may include a set of stops or end plates to prevent the vehicle from being accidentally driven or rolled off the end of the runways. Once the vehicle is in position, the vehicle lift is activated to elevate the runways (and the supported vehicle) to a working height. As an alternative to an elevating vehicle lift, the vehicle may be driven onto the runways of a vehicle support rack which is positioned over a service pit recessed into the floor, whereby the technician can conduct a vehicle service from below the vehicle without the need to elevate the vehicle above the floor surface. These “pit racks” are typically found in heavy duty truck service facilities, wherein a significant effort would be required to elevate the vehicle. Depending upon the particular configuration of the vehicle lift or support rack, movable surfaces such as turn plates and slip plates may be located on the runways between the approach end and the stops, such as shown in U.S. Pat. No. 7,308,971 to Liebetreu et al., which is herein incorporated by reference.

One of ordinary skill in the art will understand that both a vehicle lift and a support rack perform the same function of enabling a technician to access the underside of a vehicle located on the associated runway structures. For the purposes of the present disclosure, it will be understood that the term “vehicle lift” is intended to refer generically to any structure capable of supporting a vehicle in such a manner as to enable a technician to readily access the underside of the vehicle, and may include fixed support racks located over a garage floor pit or recessed service area without departing from the scope of the claimed invention.

Typically, in a vehicle service shop environment, lighting is provided by overhead illumination within the shop, however, a technician working underneath a vehicle located on a vehicle lift is often left in dark shadow. To provide the technician with sufficient lighting, vehicle lifts 100 may include white lights 102 located in or adjacent to, the runways, projecting illumination upward towards the underside of a vehicle positioned on the vehicle lift such as shown in FIG. 2. As shown in FIG. 3, each of the lights 102 may consist of an elongated fluorescent tube or LED strip 102a, a protective enclosure 102b, and a mounting bracket 102c to secure the light to the runway. Alternatively, the lights 102 may be mounted within the runway structure itself, and located to project illumination upward through a suitable opening or window 103. The lights 102 may be triggered automatically via a control relay 104 when the runways are elevated, or switched on and off by the technician as required.

During a vehicle alignment adjustment process, the technician working underneath the vehicle located observes alignment measurements and/or instructions presented on a display screen 12 associated with the alignment measurement system 10 located near the vehicle lift, or on an associated handheld device. Relying upon the display screen 12 can be awkward for the technician, as adjustments to components beneath the vehicle must be made while simultaneously observing, or repeatedly reviewing, the resulting changes to measurement values presented on the display screen or handheld device. The use of an associated handheld device alleviates some of the awkwardness resulting from constantly shifting focus, but requires the technician to find a secure location to place the device during use, and to move the device from location to location as the technician moves from wheel to wheel beneath the vehicle.

Accordingly, it would be beneficial to provide a vehicle service technician with a simple visual means to identify which wheels or vehicle components require adjustment, and an intuitive visual indication of when a wheel or component has been adjusted to within an acceptable tolerance or specification range.

### BRIEF SUMMARY OF THE DISCLOSURE

Briefly stated, the present disclosure sets forth a vehicle lift incorporating a set of colored lights disposed to illuminate the underside of a supported vehicle in proximity to each wheel of the vehicle. The lights are controlled by an associated alignment measurement or inspection system to alter a color of the illuminating light in response to measurements of alignment angles for the wheels, providing an operator with a real-time visual indication of which wheels require adjustment as well as localized wheel-specific adjustment feedback without the need for remote display devices or reliance on an operator console.

In one embodiment, upon selection by an operator of a specific wheel alignment angle, such as camber, caster, or toe, the associated alignment measurement or inspection system alters the color of the illuminating light projected by each light in the set which are in proximity to a wheel for which the selected alignment angle is out-of-spec or outside of an acceptable tolerance.

In one variation, the altered illumination is changed from a green hue to a red hue to indicate each wheel at which the selected alignment angle is out-of-spec or outside of an acceptable tolerance.

In another variation, the altered illumination is changed from a white color to a variable hue of red, orange, or yellow, providing an indication of how far a measured alignment angle for a given wheel varies from a specification value or acceptable tolerance.

In a further embodiment, each light in the set of lights is a color-controlled LED light source.

In an additional variation, each light in the set of lights comprises a set of monochromatic light sources arranged in pattern, such a linear light bar, configured to provide a visual indication for a wheel alignment angle of both a degree of deviation from a specification value or acceptable tolerance, and a direction of the deviation (i.e., positive or negative).

A method for conducting a vehicle wheel alignment adjustment or inspection begins with the measurement of a vehicle positioned on a vehicle lift having lighting systems controlled by a wheel alignment measurement system. The wheel alignment measurement system utilizes the acquired measurements to determine, for each vehicle wheel, if associated alignment angles are within acceptable tolerances of an OEM specification value, or if adjustment is required. The process proceeds in a predetermined manner, for example, by adjusting toe angles for each wheel, adjusting camber angles for each wheel, and adjusting caster angles for each wheel, or may proceed in an order determined by the operator. During adjustment of a selected alignment angle for each wheel on the vehicle, the wheel alignment measurement system operates the lift lighting systems to alter the color of illumination provided at individual wheels to provide a visual indication of an in-spec vs. out-of-spec alignment angle condition for the associated wheel.

In a further method, the wheel alignment measurement control system operates the lift lighting systems during vehicle wheel alignment adjustment or inspection procedure to provide a red hued illumination at each wheel for which one or more alignment angle measurements are considered out-of-spec or which fall outside of an acceptable tolerance range. Remaining wheels are illuminated with a white or green hued light.

In yet another method, the wheel alignment measurement control system operates the vehicle lift lighting systems during vehicle wheel alignment adjustment or inspection procedure to provide a varying hue of illumination or light at an individual wheel during adjustment of an alignment angle which is coordinated with a measure of deviation for the current value of the alignment angle from a specification value or acceptable tolerance range.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a prior art illustration of a vehicle disposed on an elevating vehicle lift in proximity to an alignment system having a display on which operator guidance is provided;

FIG. 2 is a prior art illustration similar to FIG. 1, wherein the elevating vehicle lift includes a set of white work lights mounted to an inner surface of the runways to provide vehicle underbody illumination;

FIG. 3 is a exploded perspective view of the components of the work lights shown in FIG. 2;

FIG. 4 is similar FIG. 3, illustrating a elevating vehicle lift provided with upward projecting colored lights controlled by the alignment system to provide guidance to the vehicle service technician;

FIG. 5 is similar FIG. 3, illustrating an embodiment wherein a multi-color illuminated light bar controlled by the alignment system is located on each runway inner surface to provide guidance to the vehicle service technician; and

FIG. 6 is a flow chart illustrating a method for altering lift illumination color, hue and/or intensity during a wheel alignment and/or axle angle adjustment procedure.

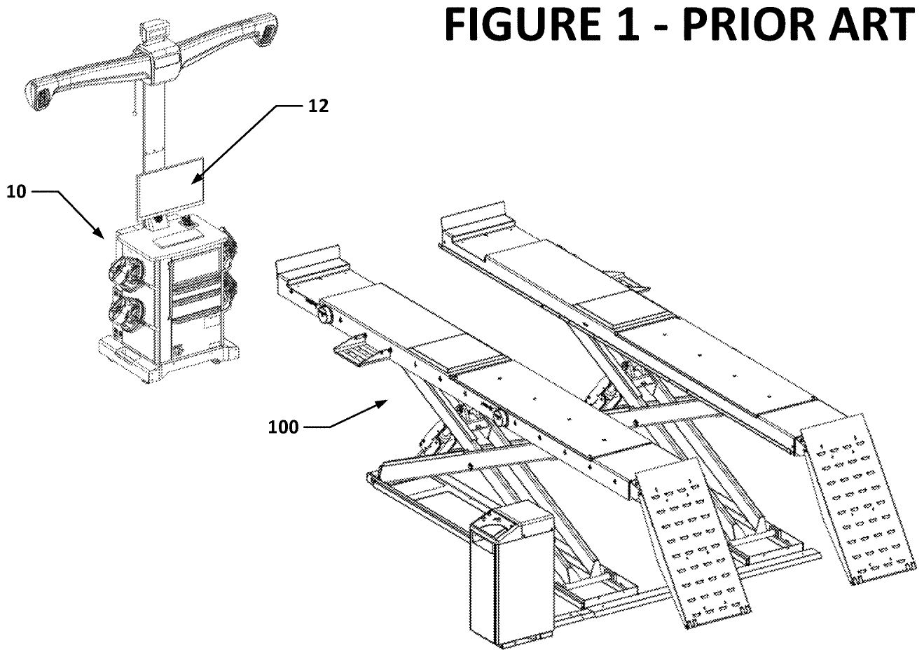

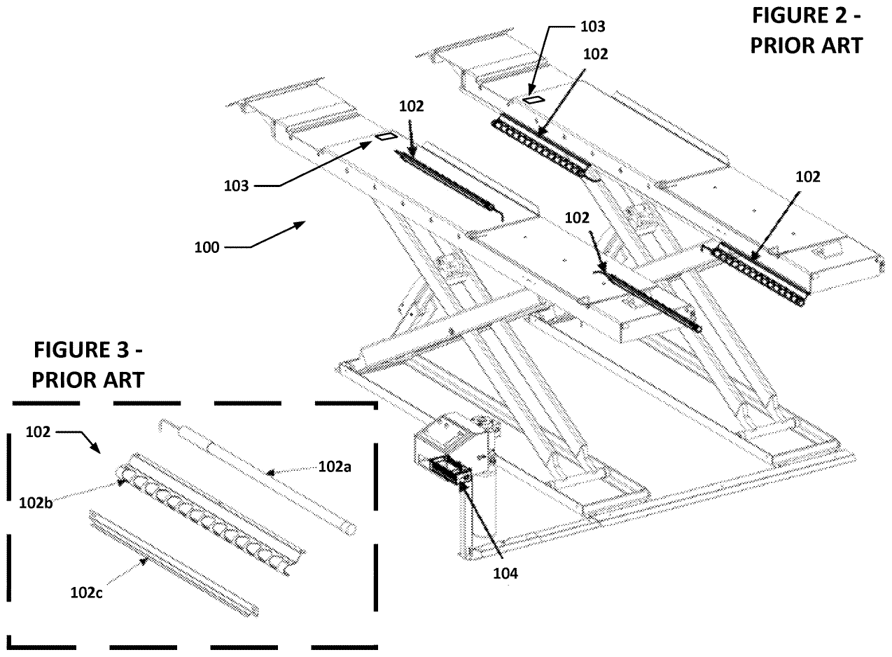

Corresponding reference numerals indicate corresponding parts throughout the several figures of the drawings. It is to be understood that the drawings are for illustrating the concepts set forth in the present disclosure and are not to scale. Before any embodiments of the disclosure are explained in detail, it is to be understood that the disclosure is not limited in its application to the details of construction and the arrangement of components set forth in the following description or illustrated in the drawings.

### DETAILED DESCRIPTION

The following detailed description illustrates the disclosure by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

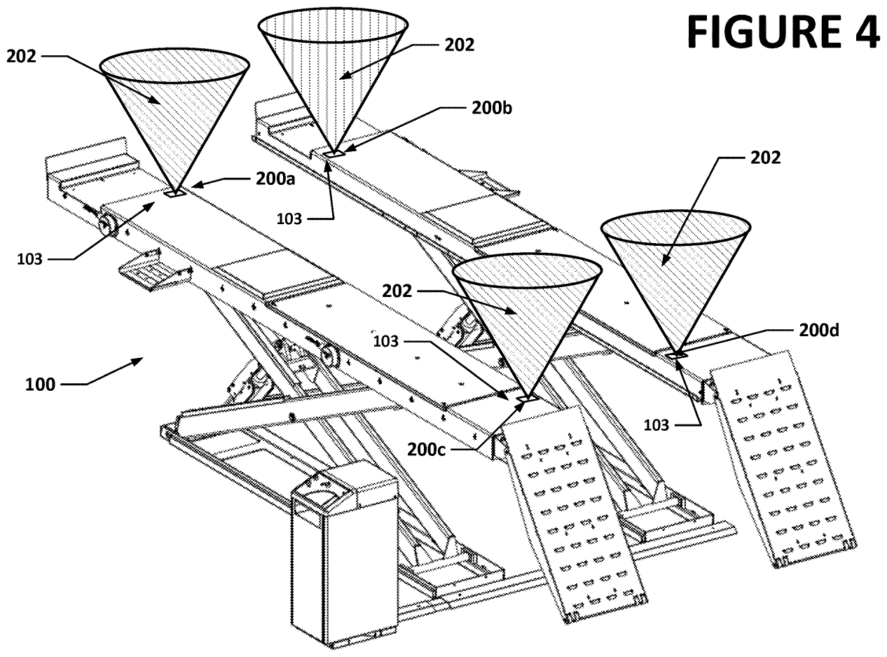

Turning to FIG. 4, a vehicle lift structure 100 incorporates a set of lights 200a-d, disposed to illuminate associated regions 202 in proximity to each wheel of a supported vehicle V. The lights 200a-d may be recessed into the surface of the vehicle supporting runways and visible through openings or windows 103 adjacent to locations where individual wheels are most likely to be positioned, or may be affixed permanently or temporarily to other surfaces of the vehicle lift structure, such as lifting arms, and oriented to illuminate the underside of a vehicle or floor surface in proximity to each individual wheel or axle. Those of ordinary skill in the art will readily recognize that the specific type and construction of the lights may be of any form suitable for the automotive service shop environment and capable of projecting colored illumination of the various hues required. Optionally, the lights may be capable of projecting static or dynamic symbolic or alpha-numeric information, such as via the use of a diffractive optical element (DOE) or controlled projection system.

Control of the individual lights 200a-d at each location on the vehicle lift structure is managed by an vehicle measurement or inspection system 10, such as a wheel alignment measurement system or ADAS calibration system, having a processor configured with software instructions to transmit control signals to individually addressable lights 200a-d of the vehicle lift structure 100 to dynamically vary at least one of color, hue, intensity, or illumination pattern of the illuminating light. The communications may be conveyed by any suitable communication means, including wired networked connections and wireless links such as Bluetooth or Wi-Fi. The processor, which may be either a dedicated light controller, or the primary processor of the alignment measurement or inspection system 10, is configure to direct alteration of the illumination in response to wheel alignment angle measurements, axle measurements, or other selected criteria, providing an operator with a visual indication of which individual wheels or axles require adjustment. For example, as the vehicle measurement or inspection system 10 proceeds through an alignment adjustment or inspection procedure for the vehicle V disposed on the lift structure, alignment values associated with individual wheels, or with individual axles on the vehicle are measured or determined. At various steps in the procedure the individual lights 200a-d associated with wheels (or axles) having an alignment value which is considered to be out-of-specification, or which falls outside of an expected range or tolerance, are illuminated with a color or hue of light which is visually distinct from the lights associated with wheels for which the alignment value is considered to be in-spec or within an expected range or tolerance. As shown in FIG. 4, in one embodiment, a wheel or axle having an out-of-specification measurement for a vehicle parameter currently being reviewed is illuminated with a red hue (denoted by the distinct cross-hatching within the relevant region 202 of FIG. 4), enabling a service technician to quickly visually identify which wheels or axles require adjustment without needing to refer to a console display 12 or associated handheld display. Lighting control may be implemented in real-time, displaying changes in color, hue, or intensity immediately in response to acquired measurements, or may be selectively implemented only during specific portions of a vehicle service procedure, such as during adjustment of specific alignment angles or parameters.

In addition to directing the color or hue of the illuminating light, the processor of the alignment measurement or inspection system 10 may be configured to selectively control a sequence in which the illuminating lights 200a-d are activated, so as to direct the service technician to a specific wheel or axle on the vehicle.

In response to an adjustment to the vehicle which alters a wheel alignment angle or axle parameter, the vehicle measurement or inspection system 10 controls the lights 200a-d associated with the wheel or axle being adjusted to project illuminating light having a color or hue which is representative a deviation of the alignment angle or axle parameter from a specific value or range. For example, a deep red color may indicate an alignment angle which is significantly out-of-spec, a yellow color may indicate an alignment angle which is within a tolerance of a specification value, while a green color may indicate an alignment angle which matches a specification value or is within a permitted range. If the lights 200a-d are capable of varying the displayed color or hue, as distinguished from lights which can only display discrete colors or hues, the vehicle measurement or inspection system 10 may control the lights 200a-d to smoothly vary the displayed color or hue as the operator performs an adjustment. Optionally, an intensity of the illumination may be controlled to represent a measure of deviation from an acceptable value or tolerance range for the selected alignment angle or axle parameter. Similarly, if a DOE or controlled optical projection system is utilized, directional arrows or text may be displayed during adjustment to provide adjustment guidance.

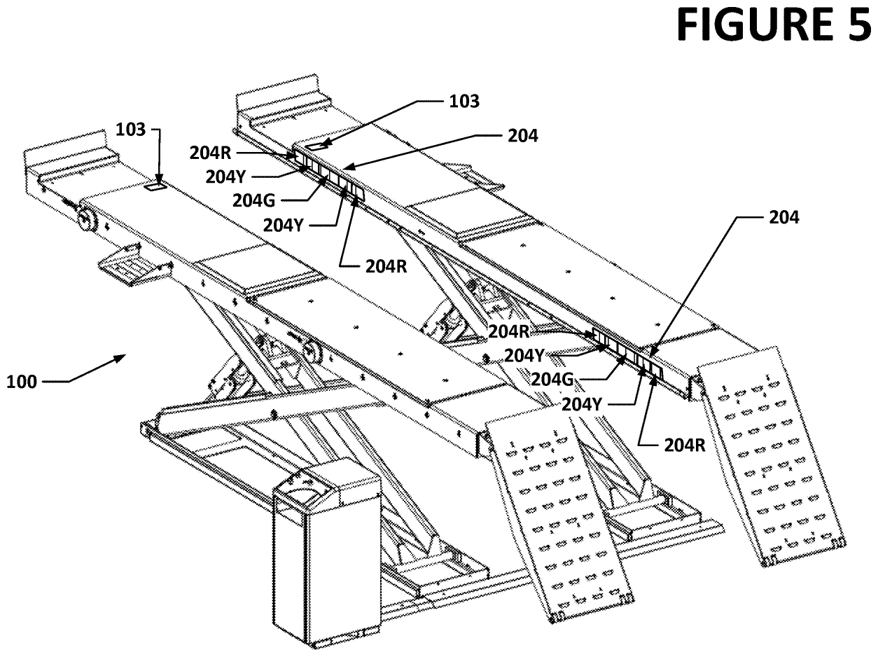

In one exemplary embodiment shown in FIG. 5, each illuminating light may be in the form of a light bar 204 configured with a combination of individual red lights 204R, yellow lights 204Y, and green lights 204G located in proximity to each wheel location on the lift runways. Each light bar 204 provides an operator with the same information traditionally presented on a bar-graph displayed on the console 12 of the vehicle measurement or inspection system 10, and may operate concurrently with white illuminating lights. The green lights 204G, centrally located on each light bar 204, is illuminated when the alignment angle or axle parameter is considered in-spec or within an acceptable tolerance range. Laterally outward from either side of the green lights 204G are yellow lights 204Y. Illumination of a yellow light 204Y laterally adjacent to a green light 204G indicates a direction (positive or negative) for which an alignment angle or axle parameter is out-of-spec or outside the acceptable tolerance range. Red lights 204R, located laterally outward from either of the yellow lights 204Y on a light bar 204, illuminate to indicate a greater deviation (positive or negative) for an alignment angle or axle parameter than indicated by the yellow lights 204Y. It will be understood that a light bar 204 including individual red, yellow and green segments, or any other monochromatic light source, may be replaced by a color-shifting light source capable of being controlled by the processing system to display selected colors in a sequence or pattern, such as may range from red-orange-yellow-green or deep-red to light-red and green, etc. without departing from the scope of the claimed invention.

By observing the illuminated lights (color, hue, location and/or intensity) during adjustment of the alignment angle or axle parameter, the service technician can visually identify (1) if an adjustment is increasing or decreasing a deviation from a specified value or tolerance range, and (2) in which direction (positive or negative) further adjustment is required. Individual lights 200a-d and/or the light bars 204 may be permanently mounted to the lift rack runways, or may be configured to be moved by an operator to positions adjacent to individual vehicle wheels, accommodating a variety of vehicles V having different wheelbase dimensions.

In a variation, the lights 200a-d and light bars 204 are housed within self-contained units which are configured for temporary or semi-permanent attachment to the vehicle lift structure 100. The self-contained units housing the lights 200a-d and light bars 204 are configured to be easily retro-fitted to existing vehicle lift structures 100 which were not originally configured with integrated illumination features, such as by hooks, magnets, or other attachment means, and may include a rechargeable power source or plug for receiving power, as well as communication circuits for receiving control signals from the vehicle measurement or inspection system processor.

Optionally, audible cues can be generated by the alignment measurement or inspection system corresponding to the selected illumination of various colored lights, enabling a color-blind service technician to utilize the system.

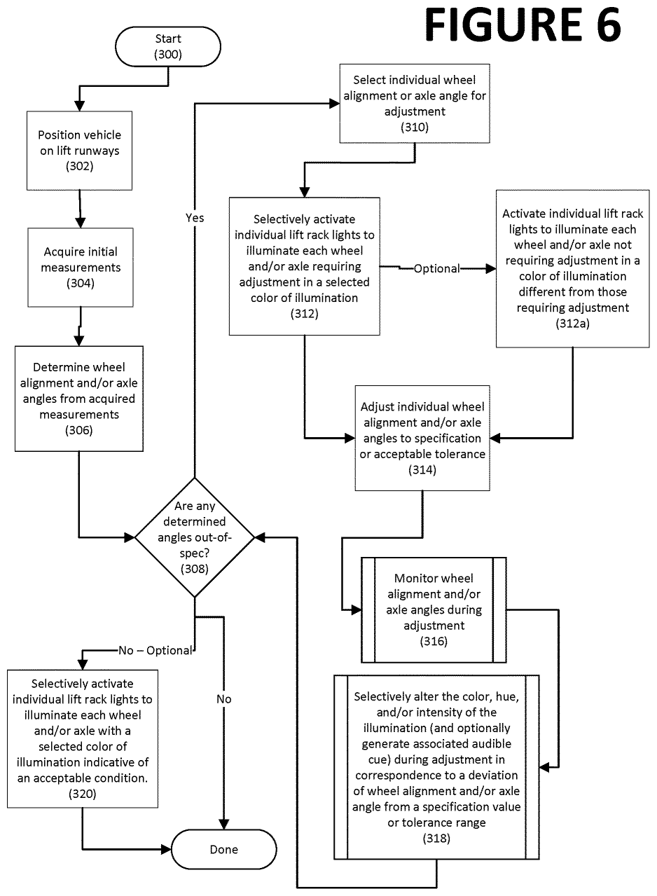

A method for conducting a vehicle wheel alignment adjustment or inspection is shown in FIG. 6. The method begins (step 300) with the positioning (step 302) and measurement (step 304) of the vehicle on a vehicle lift 100 having a lighting system controlled by a processor in a wheel alignment measurement or inspection system 10. The wheel alignment measurement system 10 utilizes acquired measurements to determine (step 306), for each vehicle wheel (and/or axle), if an associated alignment angle is within acceptable tolerances of an OEM specification value (step 308), or if an adjustment is required. In the event one or more wheel alignment and/or axle angles are determined to be out-of-spec, a suitably programmed processor identifies the corresponding wheels and/or axles to an operator for adjustment (step 310). Prompts displayed on a console or handheld display by the processor direct the service technician to proceed in a sequential manner, for example, by adjusting toe angles for each wheel, adjusting camber angles for each wheel, and adjusting caster angles for each wheel. Alternatively, the service technician may be permitted to proceed with adjustments in any order by indicating a desired selection to the processor. Prior to, and during adjustment of a selected alignment angle for each wheel on the vehicle, the processor operates the lights 200a-d, 204 to provide a visual indication of in-spec vs. out-of-spec alignment angle conditions for each wheel using differing colors, hues, locations or levels of illuminating light (steps 312, 312a).

For example, upon the operator or processor selecting wheel toe angles, the individual lights of the vehicle lift 100 are directed by the processor to illuminate, either concurrently or sequentially, each wheel having an out-of-specification toe alignment measurement with a red light. Optionally, the processor directs the individual lights 200a-d, 204 to illuminate each wheel having an in-spec or acceptable toe alignment measurements with a green or white light. Alternatively, the processor may direct the lights 200a-d, 204 to dim or turn off illuminating lights associated with wheels which do not require any adjustment. If a light bar 204 is associated with each wheel of the vehicle on the lift rack 100, the processor activates lights 204R, 204Y, and 204G for each light bar 204 as required to represent both a direction and an amount of adjustment required for the selected alignment angle at the associated wheel. If the individual lights 200a-d, 204 are capable of varying the color of an illuminating light, the processor directs the individual lights to project illuminating light having a color, hue, or intensity which is representative of the selected toe alignment measurement (and/or a deviation from specification) for the associated wheel.

As the operator makes adjustments to the selected alignment angle or vehicle parameter at an associated wheel or axle (step 314), the processor of the alignment measurement or inspection system monitors the adjustments by acquiring additional measurements from the vehicle (step 316). The processor directs the individual lights 200a-d, 204 to alter the color, hue, or intensity of light associated with the wheel or axle undergoing adjustment (step 318) to reflect changes in a deviation from the specified value or tolerance range, such as by changing from red to green (or red to yellow to green) illumination, or varying the color, hue, or an intensity of the illuminating light. The process is repeated (step 308) until all wheel alignment and/or axle angles are considered to be at specification or within an acceptable tolerance range, at which point the lights 200a-d, 204 may optionally be activated in a fashion which indicates all of the various wheel parameters are acceptable (step 320).

It will be understood that the uses of the colored lights 200a-d and light bars 204 are not limited to providing a vehicle service technician with the real-time information set forth in the specific examples provided above, and that other real-time information may be conveyed without departing from the scope of the claimed invention. For example, in a further embodiment, the colored lights 200a-d are utilized to provide the technician with real-time warnings regarding the state of an elevating vehicle lift 100. Specifically, the colored lights 200a-d may be controlled by the same control system which operates the elevating vehicle lift 100 and used to convey warnings when either the vehicle lift structure is in motion (i.e., red light during raising or lower, green light when stationary) or when the safety interlocks which prevent vehicle lift movement are disengaged. Similarly, if the vehicle lift 100 includes built-in vehicle jacks, the colored lights 200a-d may be controlled to indicate a status of the vehicle jacks (locked, unlocked, stowed, etc.).

In a further example, if the vehicle lift rack 100 is configured with tire pressure measurement and/or inflation capability, the colored lights 200a-d may be utilized to provide the technician with real-time information related to tire pressure, such as by providing a visual indication of a vehicle tire having low pressure by projecting a red or yellow colored light from the light 200a-d in proximity to the identified tire.

In yet another configuration, the operation of the colored lights 200a-d can be coordinated with input received at a controller from any of a variety of different sensors associated with the individual wheel positions on the vehicle lift 100 to provide an technician with real-time visual feedback. For example, signals from pressure sensors in the vehicle lift 100 may be utilized by a controller to activate lights 200a-d when the vehicle is moved to a specific position on the runways, signals from locking mechanisms for the lift rack turn/slip plates may be utilized by a controller to active the colored lights 200a-d to indicate locked or unlocked conditions, or signals from microphones may be used by a controller to activate the lights 200a-d to provide visual indications to a technician when specific sounds are received, such as the clicking sound of a torque wrench used to tighten the lug bolts at each wheel location.

The present disclosure can be embodied in-part in the form of computer-implemented processes and apparatuses for practicing those processes. The present disclosure can also be embodied in-part in the form of computer program code containing instructions embodied in tangible media, or another computer readable non-transitory storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a non-transitory storage medium, loaded into and/or executed by a computer, or transmitted over some transmission medium, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. A vehicle lift having a structure supporting a vehicle undergoing service, the improvement comprising:
two or more light sources mounted to said support structure, each light source spatially aligned with a corresponding vehicle wheel position for a vehicle supported by said support structure and oriented to project an illuminating light in proximity to said associated vehicle wheel; and
a vehicle measurement system associated with said vehicle lift system, said vehicle measurement system configured to control each of said two or more light sources to selectively alter a color, hue, or intensity of said projected illuminating light in response to an acquired or determined measurement or parameter of said associated vehicle wheel.

2. The vehicle lift of claim 1 wherein said vehicle measurement system is configured to selectively control each light source to project a red illuminating light in response to said acquired or determined measurement or parameter of said associated vehicle wheel deviating from a specification value or acceptable tolerance range.

3. The vehicle lift of claim 1 wherein said vehicle measurement system is configured to selectively control each light source to project a green illuminating light in response to said acquired or determined measurement or parameter of said associated vehicle wheel meeting a specification value or being within acceptable tolerance range.

4. The vehicle lift of claim 1 wherein said vehicle measurement system is configured to selectively control each light source to vary a color, hue, or intensity of said projected illuminating light in real time during an adjustment of said measurement or parameter of said associated vehicle wheel, said variance in said color, hue, or intensity representative of a change in a deviation of said measurement or parameter from a specification value or acceptable tolerance range.

5. The vehicle lift of claim 4 further including at least one audio source; and
wherein said vehicle measurement system is configured to control said at least one audio source to generate an audible signal associated with said variance in color, hue, or intensity of said projected illuminated light during said adjustment of said selected measurement or parameter of said associated vehicle wheel.

6. The vehicle lift of claim 1 wherein said acquired or determined measurement or parameter of said associated vehicle wheel is an alignment angle, including, but not limited to, toe, camber, steering axis inclination, and caster.

7. The vehicle lift of claim 1 wherein said vehicle measurement system is configured to selectively control each light source associated with wheels on a common axle of said supported vehicle to project a red illuminating light in response to said acquired or determined measurement or parameter for said common axle deviating from a specification value or acceptable tolerance range.

8. The vehicle lift of claim 1 wherein said vehicle measurement system is configured to selectively control each light source associated with wheels on a common axle of said supported vehicle to project a green illuminating light in response to said acquired or determined measurement or parameter of said common axle meeting a specification value or being within acceptable tolerance range. The vehicle lift of claim 1 wherein said vehicle measurement system is configured to selectively control each light source associated with the vehicle wheels on a common axle of said supported vehicle to vary a color, hue, or intensity of said projected illuminating light during an adjustment to said common axle, said variance in said color, hue, or intensity representative of a change in deviating of said acquired or determined measurement or parameter from a specification value or acceptable tolerance range.

10. The vehicle lift of claim 7 wherein said acquired or determined measurement or parameter of said common axle is an alignment angle, including, but not limited to total toe, thrust, or scrub.

11. The vehicle lift of claim 1 wherein each light source is a light bar including a plurality of mono-chromatic lights or at least one color-shifting LED light.

12. The vehicle lift of claim 1 wherein each light source includes a DOE or optical projection system configured to project static or dynamic symbolic or alpha-numeric elements onto a surface in proximity to an associated vehicle wheel.

13. The vehicle lift of claim 1 wherein each light source is contained with an associated housing, and wherein each housing is temporarily or semi-permanently secured to said support structure.

14. The vehicle lift of claim 13 wherein each housing further includes a rechargeable power source for said associated light source and a communications module adapted to receive light control signals from said vehicle measurement system.

15. A method for guiding adjustment of vehicle component to alter a wheel and/or axle parameters on a vehicle supported by a vehicle lift, comprising:
positioning the vehicle on the vehicle lift;
acquiring measurements associated with one or more vehicle wheel and/or axle parameters;
selecting one of said one or more vehicle wheel and/or axle parameters;
determining, for each measured vehicle wheel and/or axle, if said selected wheel and/or axle parameter is in or out of an acceptable tolerance for an associated specification value;
for each measured wheel and/or axle determined to have said selected wheel and/or axle parameter outside of an acceptable tolerance, activating a light source in proximity to said measured wheel and/or axle to project an illuminating light having a first color or hue.

16. The method of claim 15 wherein for each measured wheel and/or axle determined to have said selected wheel and/or axle parameter within an acceptable tolerance, activating said light source in proximity to said measured wheel and/or axle to project an illuminating light having a second color or hue which is visibly distinct from said first color or hue.

17. The method of claim 15 wherein said light sources are activated sequentially.

18. The method of claim 15 wherein activating said light source further includes altering said color or hue of said projected illuminating light in response to adjustments to said selected wheel and/or axle parameter.
